(19) United States
(12) Patent Application Publication
(10) Pub. No.: US 2009/0177884 A1
(43) Pub. Date: Jul. 9, 2009

(54) DIGITAL CONTENT SECURITY SYSTEM, PORTABLE STEERING DEVICE AND METHOD OF SECURING DIGITAL CONTENTS

(75) Inventors: Ker-fu Bieh, Shindian City (TW); Larry-chung Chang, Shindian City (TW)

Correspondence Address: AUSTIN RAPP & HARDMAN, 170 South Main Street, Suite 735, SALT LAKE CITY, UT, 84101, US

(73) Assignee: Benica Corporation, Shindian City (TW)

(21) Appl. No.: 11/969,633

(22) Filed: Jan. 4, 2008

(51) Int. Cl. H04L 9/00

(52) U.S. Cl. 713/168

(57) ABSTRACT

The present invention discloses a digital content security system and a method that combines information provided by both of a content provider server and a portable steering device to establish multi-way protections of the digital content from reproduction and/or playing of other unauthorized device and hacked intercept of a private key for decrypting the digital content. In application, the portable steering device has a higher compatibility with various network platforms including, for example, any common computer using a Window media player built therein.

### FIELD OF THE INVENTION

The present invention relates generally to a digital content security system, a portable steering device and a method of securing digital contents in the system, and more particularly, to a portable steering device for authentically harnessing of digital contents.

### BACKGROUND OF THE INVENTION

By contiguous evolution of network technology in support of popularization of computerization, various kinds of consumptive digital contents such as movie data, music data, executable software, online game or map data in digital form could be rapidly distributed from digital content server to each remote console/subscriber who has made a content request. The console might be realized as, for example a personal computer, PDA (Personal Digital Assistant), GPS (Global Positioning system) device or mobile phone. The network technology might denote an Internet, LAN (Local Area Network), wireless network, Bluetooth, Wi-Fi, telecommunication or the likes.

To inhibit intentional or illegal data distribution, data reproduction or media player from playing unauthorized contents, enforcing of several digital contents often need a corresponding license/certificate authorized from the digital contents providers. For example, if any user or subscriber can arbitrarily play an unauthorized reproduction of a movie by a media player without identification of the corresponding license/certificate/authenticity, this may cause the movie provider losing profit.

Thus, it is essential to establish a content protection mechanism to efficiently prevent genuine digital contents from unauthorized reproduction and usage for digital content providers.

Please refer to an illustration of FIG. 1, which presents a conventional content protection scheme 10 established among a content providing server 12, a user's personal computer 14 and a portable playing device 16. A communication for digital content transmission is established over a network (i.e. Internet) 122 between the content providing server 12 and the personal computer 14. An USB (Universal serial bus) connection 142 for digital content transmission is established between the personal computer 14 and the portable playing device 16, wherein the portable playing device 16 might be as a flash disk, a USB drive or various kinds of memory cards, which is plugged in an USB I/O port of the personal computer 14 and only plays back the protected digital content. In the conventional content protection scheme 10, all protected digital contents can be accessible from the content providing server 12 only by enforcing a content protection policy on the portable playing device 16, rather than the personal computer 14.

If the user wishes to play a digital content on his/her personal computer 14 by making a purchase or subscription request from the personal computer 14 via the network 122, an authentication between the content providing server 12 and the personal computer 14 is verified by the content providing server 12, with a hardware information of the personal computer 14 which has been reported to the content providing server 12.

If the authentication of the personal computer 14 is valid, the digital content is downloaded from the content providing server 12 to the personal computer 14 via the network 122. Then the personal computer 14 exchanges coding keys with the content providing server 12 and transfers the protected digital content and the corresponding coding key to the portable playing device 16 over the USB connection 142. The portable playing device 16 would enumerate all available contents thereon for picking up.

The portable playing device 16 that substantially plays the content protection role utilizes the coding key to decrypt the protected digital content and play the digital content such as movie, music, game or map. However, the portable playing device 16 can not restrict the digital content from being freely reproduced to other different devices for playing with verification, and has a low compatibility with various network platforms including the personal computer 14 because the hardware information of the personal computer 14 must be reported to the content providing server 12.

Further referring to an illustration of FIG. 2, another type conventional content protection scheme 20 is presented, which is established over a network (i.e. Internet) 222 between a content providing server 22 and a user's personal computer 24. A media playing unit 26 as a dedicated media player program must pre-register with the personal computer 24 to establish proximity and might be only plays back the digital content, not allowed to persist the digital content. In the conventional content protection scheme 20, all protected digital contents can be accessible from the content providing server 12 only by enforcing the protection policy on the content providing server 22 to the personal computer 24.

While the user wishes to play a specific digital content on his/her personal computer 24 by performing a purchase or subscription request from the personal computer 24 via the network 222 for the protected digital content, the media playing unit would consult with the content providing server 22 wherein an authentication between the content providing server 22 and the personal computer 24 is verified by the content providing server 22, with an information relative to the personal computer 24 or the media playing unit 26, which has been pre-provided to the content providing server 22.

If the authentication of the personal computer 24 is valid, the digital content is permitted to download from the content providing server 22 to the personal computer 24 via the network 222. During data streaming over the network, the media playing unit 26 of the personal computer 24 would use a corresponding coding key exchanged with the content providing server 22 to decrypt the protected digital content and then play the decrypted digital content.

Under the above-mentioned conventional content protection schemes, implementations of all protection of the digital content must be restricted on either a predetermined system (i.e. the personal computer) or an incorporation of a predetermined media player (i.e. the media playing program) with the predetermined system. It means that genuine digital contents can not be enforced across different system without re-acquirement of additional license from the content providing server. Since the predetermined system (i.e. the personal computer) or the predetermined media player (i.e. the media playing program) needs to have a communication with the content providing server to acquire a license/certificate/register authorized from the content providing server before playing protected digital contents. In this communication, the information relative to the predetermined system is provided to the content providing server. At each time when a request for digital contents is submitted, the information of the predetermined system must be authenticated by the content providing server so as to decide whether to download the protected digital contents into the predetermined system for playing of the media player. On the contrary, if other different system without a pre-registered information can not acquire a newly additional license issued from the content providing server, the protected digital contents can not be downloaded and played across the other different systems.

Although Microsoft Inc. has proposed a DRM (Digital Right Management) design so as to establish a digital content protection protocol with use of a public key for encrypting the digital content and a corresponding private key for decrypting the digital content, this is still easily hacked by intercepting the private key on the way of forwarding the private key to the user terminal via the Internet.

Accordingly, what is desired is a more effective contents protection that can be established on different system as long a genuine copy of digital contents is respectively requested by the different system.

### SUMMARY OF THE INVENTION

To resolve the drawbacks of the above-mentioned conventional schemes, a primary objective of the present invention is to provide a portable steering device which is dedicated to restrict the digital content from being freely reproduced and/or playing in other different unauthorized device without further verification.

A secondary objective of the present invention is to provide a portable steering device in applications which has a higher compatibility with various network platforms including, for example, any common computer using a Window media player built therein.

A third objective of the present invention is to provide a digital content security system and a method that combines information of both content providing server and portable steering device to establish multi-way protections of the digital content, unlike the prior art which relies on solely one side protection as either a content providing server or a media playing device.

A fourth objective of the present invention is to provide a digital content security system and a method that combines information respectively provided from both of a content providing server and a portable steering device to establish multi-way protections of the digital content from playing by a hacked device and a hacked intercept of a private key on the Internet.

To accomplish the above-mentioned objectives, the present invention discloses a digital content security system, a portable steering device and a method of securing digital contents in the system.

The digital content security system includes a remote computerized device, a proximate computerized device communicated with the remote computerized device via a network, and a portable steering device.

The remote computerized device is as a content provider's server which has an authentication key validation unit, a first coding key and an authentication key. The first coding key as a public key is used to produce and be embedded within encrypted digital content by combining a device unique serial number relative to the portable steering device and a content class key relative to the digital content. The proximate computerized device is as the user's personal computer having a media playing unit such as a Window media player.

The portable steering device is as a card type memory device, which includes a controller and a memory unit. The controller has executable codes containing a first coding key validation unit for validating the first coding key. The memory unit is configured by the controller to divide into a non-reproducible content area which inhibits reproduction to other than the device by modifying access pointer of a memory address, and a reproducible content area. Before the portable steering device communicates with the proximate computerized device via an I/O bus, the non-reproducible content area has a hidden cipher content subarea for accommodating another authentication key and a second coding key as a private key produced corresponding to the first coding key, and the reproducible content area preloads the encrypted digital content embedded with the first coding key. After the portable steering device communicates with the proximate computerized device, the authentication key is send from the non-reproducible content area of the portable steering device to the remote computerized device via the proximate computerized device.

After communicated with the proximate computerized device, the portable steering device also install a software module from the non-reproducible content area into the media playing unit of the proximate computerized device for supporting the media playing unit to play back the encrypted digital content with the second coding key later.

When the authentication key forwarded from the non-reproducible content area of the portable steering device is valid by the authentication key validation unit, the remote computerized device sends the first coding key thereof to the portable steering device via the proximate computerized device. Then if the first coding key forwarded from the remote computerized device is valid by the first coding key validation unit according to another first coding key embedded with the encrypted digital content, the portable steering device sends the second coding key thereof to the proximate computerized device via the I/O bus and thereby permits the media playing unit to play back the digital content with decryption of the second coding key.

Beside, the present invention further propose a method of securing digital contents in a system which has a remote computerized device, a proximate computerized device having a media playing unit, and a portable steering device. The method comprises the following steps of:

preloading encrypted digital content and preloading an authentication key and a private key in the portable steering device, and preloading a public key in the remote computerized device, before the portable steering device communicates with the proximate computerized device;

sending the authentication key from the portable steering device to the remote computerized device via the proximate computerized device and installing a software module from the portable steering device to the media playing unit of the proximate computerized device after the portable steering device communicates with the proximate computerized device;

if the authentication key is valid by validation of the remote computerized device, sending a public key produced corresponding to the private key, from the remote computerized device to the portable steering device via the proximate computerized device;

if the public key is valid by validation of the portable steering device, sending the private key from the portable steering device to the media playing unit of the proximate computerized device; and

reading the encrypted digital content from the portable steering device to the media playing unit installed with the software module to play back by using the private key to decrypt the encrypted digital content.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 illustrates a conventional content protection scheme and policy that performs a digital content protection only by a portable playing device;

FIG. 2 illustrates another conventional content protection scheme and policy that performs a digital content protection only by the content providing server;

FIG. 3A is a block diagram of a digital content security system according to a preferred embodiment of the invention;

FIG. 3B is a block diagram of a portable steering device according to the preferred embodiment of the invention; and

FIG. 4 is a flow chart of a method of securing digital contents according to the preferred embodiment of the invention.

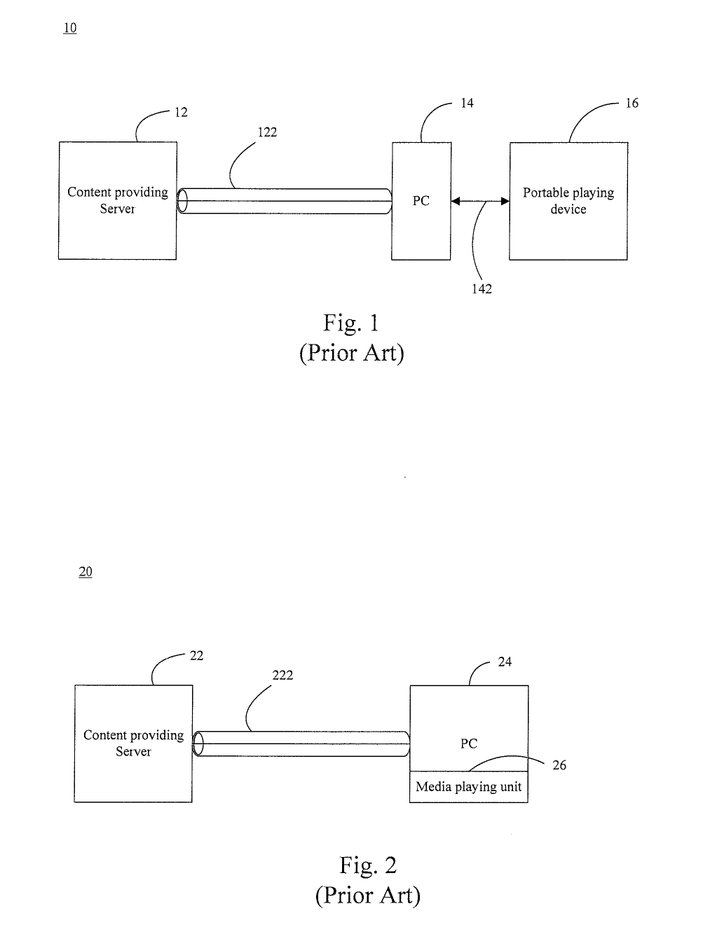

### DETAILED DESCRIPTION OF THE INVENTION

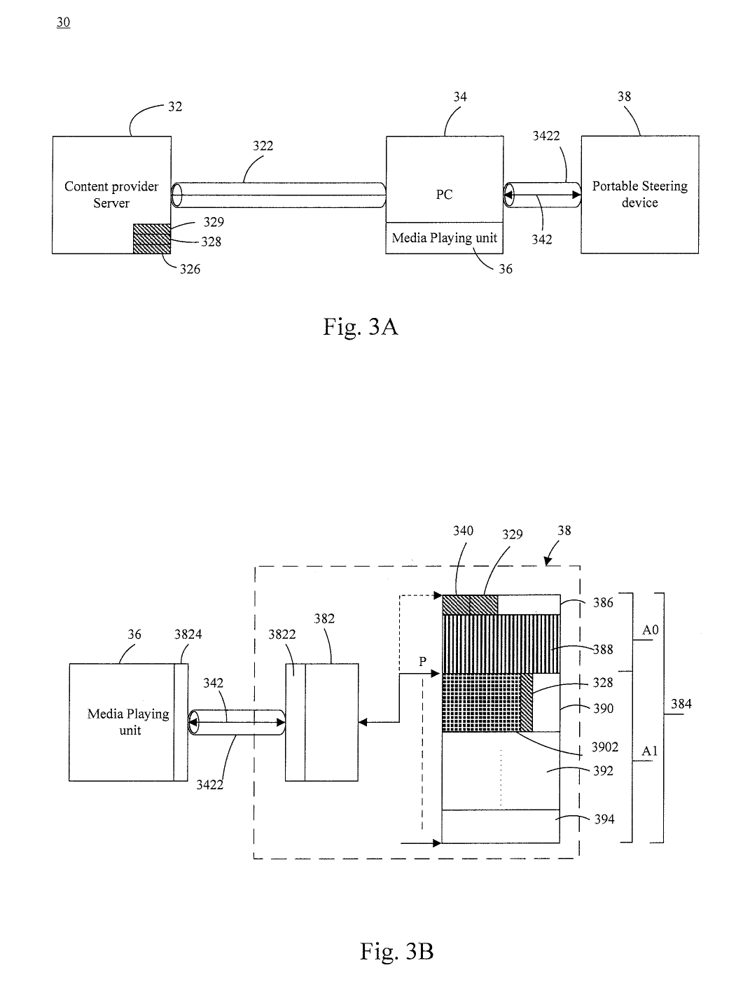

Firstly referring to FIGS. 3A and 3B, according to a preferred embodiment of the present invention, a digital content security system 30 with multi-way authentication for securing digital contents is presented hereinafter. The digital contents can be realized as a movie/music/game/program/map in digital form.

The digital content security system 30 includes a remote computerized device 32 (i.e. a content provider's server), a proximate computerized device 34 (i.e. the user's personal) communicated with the remote computerized device 32 via a network 322 (i.e. the Internet), and a portable steering device 38 which can plug in the proximate computerized device 34 via a Input/output (I/O) BUS connection as an USB connection 342.

The remote computerized device 32 has an authentication key validation unit 326, a first coding key 328 and an authentication key 329. The proximate computerized device 34 contains a media playing unit 36 as a Window media player built therein. The Window media player can support DRM (Digital Right Management) technology. Further referring to FIGS. 3A and 3B, the portable steering device 38 is realized as a card type memory device, for example, a USB drive, SQ card, SD/MMC card, xD card, SD card and the likes, which primarily includes a controller 382 and a memory unit 384.

The controller 382 is embedded with a firmware 3822 as the executable codes, which contains a first coding key validation unit for validating the first coding key 328. The memory unit 384 is configured by the controller 382 to divide into a non-reproducible content area A0 and a reproducible content area A1. The non-reproducible content area A0 inhibits reproduction to other than the device 38 by modifying an access pointer ‘P’ of a memory address and further contains a hidden cipher content subarea 386 and an application program (AP) subarea 388. The application program (AP) subarea 388 of the non-reproducible content area A0 of the device 38 is used to accommodate an application program for auto-installing a software module 3824 to support the proximate computerized device 34. The reproducible content area A1 can be divided into several subarea 390, 392 and 394 for different ways, for example the subarea 394 can be configured as a free space on the user demands.

In this embodiment, the portable steering device 38 might be pre-registered in the remote computerized device 32 or an intermediate key infrastructure (not shown) between the remote computerized device 32 and the proximate computerized device 34 and preloaded a dedicated digital content 3902, before the portable steering device 38 is communicated with the proximate computerized device via the USB connection 342 (as during a fabrication process before the device 38 is purchased by the user) for initialization. In this fabrication process, there were a plurality of first coding keys 328 identical with each other, a plurality of authentication keys 329 identical with each other, and a second coding key 340 pre-produced and distributed by either the remote computerized device 32 or the intermediate key infrastructure. For example, one of the first coding keys 328 was used to encrypt the digital content (i.e. the numeral reference 3902) and then was embedded within the encrypted digital content 3902 which was for later preloading within the portable steering device 38 (as shown in FIG. 3B), wherein the first coding key 328 (i.e. a public key) for encrypting the digital content 3902 combined a device unique serial number relative to the portable steering device 38 and a content class key relative to the digital content 3902. Beside, the other first coding key 328 and one of the authentication keys 329 were respectively stored within the remote computerized device 32 (as shown in FIG. 3A). Then, the other authentication key 329, the second coding key 340 and the encrypted digital content 3902 embedded with the first coding key 328 were respectively preloaded into the portable steering device 38 (as shown in FIG. 3B). The second coding key 340 (i.e. a private key) for decrypting the encrypted digital content 3902 is produced corresponding to the first coding key 328. During the first coding key 328 encrypts the digital content 3902 in the remote computerized device 32, the authentication keys 329 as an ID are produced based on either the digital content 390 or the portable steering device 38.

Therefore, before the portable steering device 38 communicates with the proximate computerized device 34 to play the digital content 3902 (or before the user purchases the portable steering device 38), the encrypted digital content 3902 has been preloaded into the reproducible content area A1 (i.e. subarea 390) of the portable steering device 38, and the authentication key 329 and the second coding key 340 have been preloaded in the hidden cipher content subarea 386 of the non-reproducible content area A0 of the portable steering device 38.

After the portable steering device 38 communicates with the mote computerized device 32 via the proximate computerized device 34 so as to play the encrypted digital content 3902 later, the application program (AP) 388 of the portable steering device 38 would be executed by the firmware 3822 of the controller 382 to auto-install a software module 3824 into the media playing unit 36 of the proximate computerized device 34 over the USB connection 342. The software module 3824 can cooperate with the firmware 3822 of the controller 382 to forward the authentication key 329 from the hidden cipher content subarea 386 of the non-reproducible content area A0 of the portable steering device 38 to the remote computerized device 32 via the proximate computerized device 34 and the network 322. Also, the software module 3824 can support the media playing unit 36 to play back the encrypted digital content 3902 later with decryption of the second coding key 340 in the proximate computerized device 34. In other application as shown in FIGS. 3A and 3B, to strengthen a transmission security, the software module 3902 can further establish a data communication protocol 3422 (like a data-scrambling process) over the USB connection 342 between the proximate computerized device 34 and the portable steering device 38. Therefore, under the data communication protocol 3422, keys or data transmission for playing back the encrypted digital content 3902 with decryption of the second coding key 340 all can be protected from intentional interception.

When a validity of the authentication key 340 forwarded from the portable steering device 38 is validated by the authentication key validation unit 326 of the remote computerized device 32 according to the other authentication key 340 pre-stored within the remote computerized device 32, the remote computerized device 32 sends back the first coding key 328 thereof to the portable steering device 38 via the proximate computerized device 34. Then if a validity of the first coding key 328 forwarded from the remote computerized device 32 is validated by the first coding key validation unit of the firmware 3822 according to the other first coding key 328 embedded within the encrypted digital content 3902 in the producible content area A1, the firmware 3822 of the portable steering device 38 will allow to send the second coding key 329 from the non-producible content area A0 to the proximate computerized device 34 via the USB connection 342 and thereby permits the media playing unit 36 installed with software module 3824 to play back the encrypted digital content 3902, which is read from the from the subarea 390 of the producible content area A1, with decryption of the second coding key in the proximate computerized device 34.

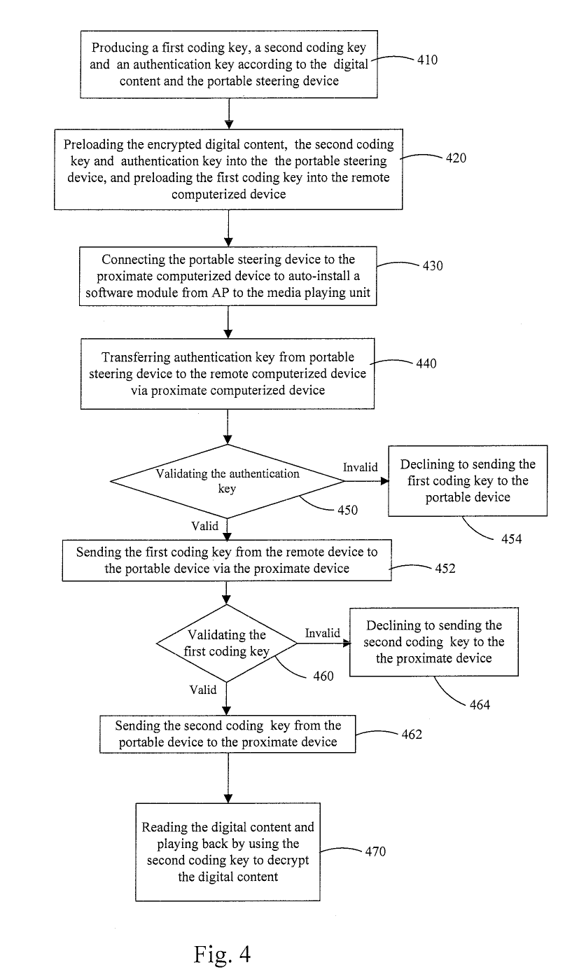

Furthermore referring to FIG. 4, according to the preferred embodiment of the present invention, a method of securing digital contents in a system as shown in FIGS. 3A and 3B is proposed hereinafter. The digital contents can be realized as a movie/music/game/program/map in digital form. The system has a remote computerized device (i.e. the content provider's server) having an authentication key validation unit, a proximate computerized device (i.e. the user's personal computer) having a media playing unit (i.e. a Window media player), and a portable steering device that has a controller containing a first coding key validation unit, and a memory unit divided by the controller into a non-reproducible content area and a reproducible content area for other than the portable steering device, wherein the remote computerized device can communicate with the proximate computerized device via a network (as the Internet), and the proximate computerized device can communicate with the portable steering device via an I/O bus (like USB) connection. The method comprises the following steps of:

Step 410, by the portable steering device pre-registering in the remote computerized device or an intermediate key infrastructure (for example, before the user purchases the portable steering device), producing a plurality of first coding keys identical with each other, one of (i.e. a public key) which is used to encrypt the digital content and then embedded within the encrypted digital content based on combination of a device unique serial number relative to the portable steering device and a content class key relative to the digital content, and producing a second coding key (i.e. a private key) corresponding to the first coding key, which is used to decrypt the encrypted digital content, and producing a plurality of authentication keys identical with each other, one of which is located on a hidden cipher content subarea in the non-reproducible content area of the portable steering device;

Step 420, before the portable steering device communicates with the proximate computerized device, preloading the encrypted digital content embedded with the first coding key into the reproducible content area of the portable steering device, and preloading the authentication key and the second coding key in the non-reproducible content area of the portable steering device, and preloading another first coding key and another authentication key to the remote computerized device;

Step 430, connecting the portable steering device to the proximate computerized device via the USB connection to auto-install a software module from an application program area in the non-reproducible content area to the media playing unit for supporting the media playing unit later to play back the encrypted digital content;

Step 440, when the user wishes to play the encrypted digital content on the proximate computerized device, the media playing unit consults with the remote computerized device to transfer the authentication key from the non-reproducible content area of the portable steering device to the remote computerized device via the proximate computerized device;

Step 450, if a validity of the authentication key forwarded from the non-reproducible content area of the portable steering device is validated by the authentication key validation unit of the remote computerized device according to another authentication key pre-stored within the remote computerized device, then as shown the step 452, sending the first coding key from the remote computerized device to the portable steering device via the proximate computerized device, and otherwise as step 454, declining to send the first coding key to the portable steering device and thereby protecting the encrypted digital content from reproduction and playing of other unauthorized device;

Step 460, if a validity of the first coding key forwarded from the remote computerized device is valid by the first coding key validation unit of the portable steering device according to another first coding key embedded within the encrypted digital content of the portable steering device, then as shown in step 462, sending the second coding key from the non-reproducible content area of the portable steering device to the proximate computerized device, and otherwise as step 464, declining to send the second coding key to the proximate computerized device and thereby protecting the second coding key used on decryption of the encrypted digital content from hacked intercept on the Internet; and

Step 470, reading the encrypted digital content from the reproducible content area of the portable steering device to the media playing unit installed with the software module to play back by using the second coding key to decrypt the encrypted digital content.

In conclusion, the present invention discloses a digital content security system and a method that combines information of both content provider's server (as first coding key) and portable steering device (as authentication key and second coding key) to establish multi-way protections of the digital content, rather than the prior art that relies on either solely the content providing server or the media playing device. Also, the protection can prevent the digital content from playing by a hacked device and prevent a private key for decrypting the digital content from hacked intercept during delivery on the Internet. Thus, in the present invention, all protected digital content can be securely accessible by enforcing the digital content protection policy on both content providing server and the portable steering device which registers with PC to establish proximity. Beside, the portable steering device of the present invention can restrict the digital content from being freely reproduced to other different media playing device and playing without further verification, and has a higher compatibility with various network platforms including, for example, any computer using a Window media player built therein.

Although this invention has been described in certain specific embodiments, those skilled in the art will have no difficulty devising variations to the described embodiment which in no way depart from the scope and spirit of the present invention. Furthermore, to those skilled in the various arts, the invention itself herein will suggest solutions to other tasks and adaptations for other applications. It is the Applicants' intention to cover all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive.

What is claimed is:

1. A digital content security system for securing digital content, comprising:
a remote computerized device storing at least a first coding key for encrypting the digital content;
a proximate computerized device communicated with the remote computerized device via a network, having a media playing unit; and
a portable steering device which preloads the encrypted digital content, an authentication key and a second coding key before communicated with the proximate computerized device via an USB connection, wherein the media playing unit is permitted to achieve the second coding key from the portable steering device and thereby decrypt and play back the encrypted digital content, based on a validity of the authentication key which is validated by the remote computerized device and a validity of the first coding key which is validated by the portable steering device.

2. The system as defined in claim 1, wherein the remote computerized device is a server having an authentication key validation unit used for validating the authentication key, and the portable steering device is a card type memory device having a first coding key validation unit used for validating the first coding key.

3. The system as defined in claim 1, wherein the proximate computerized device is a personal computer, and the media playing unit is a Window media player.

4. The system as defined in claim 2, wherein a plurality of authentication keys identical with each other, a plurality of first coding keys identical with each other, and the second coding key are produced by either the remote computerized device or an intermediate key infrastructure.

5. The system as defined in claim 4, wherein before the portable steering device is communicated with the proximate computerized device via the USB connection, one of the first coding keys is used to encrypt the digital content and embedded within the encrypted digital content, the other first coding key and one of the authentication keys are respectively stored within the remote computerized device, and the other authentication key, the second coding key and the encrypted digital content embedded with the first coding key are respectively preloaded into the portable steering device.

6. The system as defined in claim 5, wherein during the first coding key encrypts the digital content, the authentication keys are produced based on either the digital content or the portable steering device.

7. The system as defined in claim 6, wherein the first coding key is a public key which combines a device unique serial number relative to the portable steering device and a content class key relative to the digital content, the second coding key is a private key corresponding to the first coding key.

8. The system as defined in claim 7, wherein the portable steering device further has a non-reproducible content area which preloads the authentication key and the second coding key thereto and inhibits reproduction to other than the portable steering device, and a reproducible content area for preloading the encrypted digital content embedded with the first coding key thereto.

9. The system as defined in claim 8, wherein after communicated with the proximate computerized device via the USB connection, the portable steering device sends the authentication key thereof to the remote computerized device via the proximate computerized device.

10. The system as defined in claim 9, wherein after validity of the send authentication key is validated by the authentication key validation unit and the authentication key in the remote computerized device, the remote computerized device sends the first coding key thereof to the portable steering device via the proximate computerized device.

11. The system as defined in claim 10, wherein after validity of the send first coding key is validated by the first coding key validation unit in the proximate computerized device according to the first coding key embedded within the encrypted digital content, the portable steering device sends the second coding key thereof to the proximate computerized device via the USB connection to permit the media playing unit playing back the encrypted digital content with decryption of the second coding key.

12. The system as defined in claim 11, wherein after communicated with the proximate computerized device via the USB connection, the portable steering device installs a software module into the media playing unit of the proximate computerized device to support the media playing unit to play back the encrypted digital content with decryption of the second coding key.

13. The system as defined in claim 12, wherein the software module can establish a data communication protocol over the USB connection between the proximate computerized device and the portable steering device, and support the media playing unit to play back the encrypted digital content with decryption of the second coding key under the data communication protocol.

14. A portable steering device connected to an external media player, comprising:
a controller having executable codes at least one portion of which can validate an external first coding key send from the external media player; and
a memory unit configured by the controller into a non-reproducible content area which inhibits reproduction to other than the device and preloads an authentication key and a second coding key thereon, and an reproducible content area which preloads encrypted digital content, before the device is connected with the external media player, wherein the authentication key is provided from the non-reproducible content area to the external media player after the device is connected with the external media player, and the second coding key is provided from the non-reproducible content area to the external media player to decrypt the encrypted digital content, based on whether the external first coding key is valid by the portion of the executable code of the controller.

15. The device as defined in claim 14, wherein the portion of the executable codes further contain a first coding key validation unit for validating the external first coding key, according to another first coding key embedded within the encrypted digital content.

16. The device as defined in claim 14, wherein the non-reproducible content area inhibits reproduction to other than the device by modifying access pointer of a memory address.

17. The device as defined in claim 14, wherein the non-reproducible content area further contains an application program area, which can install a software module into the external media player to play back the encrypted digital content with usage of the second coding key.

18. The device as defined in claim 17, wherein the external first coding key is a public key for producing the encrypted digital content, which combines a device unique serial number relative to the portable steering device and a content class key relative to the encrypted digital content, and the second coding key is a private key produced corresponding to the external first coding key, which is used to decrypt the encrypted digital content.

19. A method of securing digital content in a system which has a remote computerized device, a proximate computerized device and a portable steering device, comprising the following steps of:
preloading encrypted digital content, an authentication key and a private key into the portable steering device before the portable steering device communicates with the proximate computerized device;
sending the authentication key from the portable steering device to the remote computerized device via the proximate computerized device after the portable steering device communicates with the proximate computerized device;
if the authentication key is valid by validation of the remote computerized device, sending a public key produced corresponding to the private key, from the remote computerized device to the portable steering device via the proximate computerized device; and
if the public key is valid by validation of the portable steering device, sending the private key from the portable steering device to the proximate computerized device thereby playing back the encrypted digital content with decryption the private key in the proximate computerized device.

20. The method as defined in claim 19, wherein the public key that combines a device unique serial number relative to the portable steering device and a content class key relative to the digital content is used to produce the encrypted digital content.

21. The method as defined in claim 19, wherein after the portable steering device communicates with the proximate computerized device, installing a software module from the portable steering device into the proximate computerized device to support the proximate computerized device to play back the encrypted digital content with decryption of the private key.
